(19) United States
(12) Patent Application Publication
(10) Pub. No.: US 2011/0290532 A1
(43) Pub. Date: Dec. 1, 2011

(54) HEADPHONE CORD SLEEVE

(76) Inventor: Miguel A. Cano, JR., Chicago, IL (US)

(21) Appl. No.: 13/118,359

(22) Filed: May 27, 2011

Related U.S. Application Data
(60) Provisional application No. 61/396,573, filed on May 28, 2010.

(51) Int. Cl. H01B 7/00; B23P 19/04

(52) U.S. Cl. 174/135; 29/428

(57) ABSTRACT

A headphone cord sleeve includes: a flexible tubular sleeve including an opening at each of a first end and a second end; a reinforced section of the tubular sleeve adjacent the first end reducing the flexibility of the tubular sleeve over the length of the reinforced section; and a loop extending from the side wall of the flexible tube, adjacent to the reinforced section. A method of managing a headphone cord comprising the steps of: providing a tubular sleeve including a first opening and a second opening; positioning the tubular sleeve onto a headphone cord, wherein the headphone cord includes a jack plug, a jack cord, a cord split, a pair of earbud cords and a pair of earbud housings; and selectively positioning the tubular sleeve between a use position and a storage position.

### CROSS-REFERENCE TO RELATED APPLICATIONS

This application incorporates by reference and claims priority to U.S. Provisional Patent Application No. 61/396,573 filed May 28, 2010.

### BACKGROUND OF THE INVENTION

The present subject matter relates generally to a headphone cord sleeve that helps to provide tangle free storage for the headphone cords. More specifically, the present invention relates to headphone cord sleeve that reduces the number of total cord ends from three to two when the headphone cord sleeve is placed in the storage configuration.

The use of portable music players, particularly relatively small digital audio players (including smartphones including audio playback functionality), typically brings along a corresponding use of headphones. Many of the headphones used in these applications, particularly headphones embodying the ear buds style, are compact and, accordingly, users tend to carry the headphone in pockets, purses, bags, etc. In these situations, the headphone cords, particularly the portions of the cords leading to the ear pieces can become tangled. Tangled cords can be difficult to untangle before use and can lead to the degradation of the integrity of the headphones.

Currently available cord management solutions typically require that the cord be wound around a small frame of some kind. This is time consuming and can also damage the cord over time. Other cord management solutions require placement of the cord onto a pulley or otherwise mechanized assembly of transformation. The mechanized assembly creates considerable added bulk in storage mode and is complex to use, constraining the end user.

Accordingly, a need exists for a cord management device that requires no winding and is ready for storage with one quick simple movement of sliding the sleeve into storage position, thereby eliminating time consuming and potentially damaging steps. In addition there is a need for a cord management device that is a single part that is a flexible conforming part that adds minimal bulk to the cord in both the storage position and use-position and is very easy to use.

### BRIEF SUMMARY OF THE INVENTION

The headphone cord sleeve disclosed herein is an easy to use, effective, minimally bulky solution for headphone cord management. The headphone cord sleeve provided herein allows tangle-free storage of headphone cords by reducing the number of total cord ends from three to two in a continuous fashion with no gaps or openings.

The headphone cord sleeve is a flexible hollow sleeve with two open ends that easily slides over headphone cords for quick tangle free transformation between use and storage positions. Use position is defined as having the earbud cords and jack plug generally unconstrained by the sleeve and available for use. Storage position is defined as having the headphone cords together within the sleeve and behaving as though they are one continuous cord. Transformation out of storage position is accomplished by sliding from the opposite end, i.e., the back open end.

The headphone cord sleeve utilizes stitching on the front open end that provides a stiffening effect on the sleeve which allows it to overcome the cord split, microphone, and earbud housings while traveling up the cord to the storage position. The stiffening effect can also be provided by a separate part attached to the sleeve at the front open end and/or back open end.

In the storage position the invention constrains the two earbud cords causing them to generally behave as one single cord greatly reducing the tendency to tangle when stored in a tight space, e.g., pocket or bag.

The headphone cord sleeve is made from a flexible material, e.g., any fabric synthetic or natural, polyester, canvas, linen, silicone, etc. allowing it to bend and to conform to whatever shape is convenient for the end user.

In addition the headphone cord sleeve design is such that when in storage mode the headphone jack plug can be captured through the label, forming a loop, allowing the cord to be more resilient to tangling given that there are no loose ends in this configuration. In one example, a headphone cord sleeve includes: a flexible tubular sleeve including an opening at each of a first end and a second end; a reinforced section of the tubular sleeve adjacent the first end reducing the flexibility of the tubular sleeve over the length of the reinforced section; and a loop extending from the side wall of the flexible tube, adjacent to the reinforced section. The loop may be a product label. The reinforced section may include stitching in the flexible tubular sleeve. A tool may be located through the tubular sleeve to grasp a headphone cord to pull the headphone cord into and through the headphone cord sleeve.

In one example, a method of managing a headphone cord includes the steps of: providing a tubular sleeve including a first opening and a second opening; positioning the tubular sleeve onto a headphone cord, wherein the headphone cord includes a jack plug, a jack cord, a cord split, a pair of earbud cords, a microphone and a pair of earbud housings; and selectively positioning the tubular sleeve between a use position and a storage position. In the use position, the jack plug is uncovered and adjacent to the first opening of the tubular sleeve and/or the cord split is uncovered and adjacent to the second opening of the tubular sleeve. In the storage position, the tubular sleeve covers the cord split and the pair of earbud cords. The tubular sleeve may be positioned onto the headphone cord by pulling the headphone cord through the tubular sleeve using a tool provided in the tubular sleeve.

An advantage of the headphone cord sleeve is that it provides a fast, easy to use, effective, minimally bulky solution for headphone cord management.

Another advantage of the headphone cord sleeve is that it allows the storage of headphones in a pocket or bag with minimal risk of tangling.

A further advantage of the headphone cord sleeve is that it does not require winding of the headphone cord, which helps reduce stress on the cord and eliminates the time necessary to wind and unwind the cord.

Yet another advantage of the headphone cord sleeve is the simplicity and quickness of moving the headphone cord sleeve between the use position and the storage position.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of a headphone cord sleeve and a generic representation of a headphone.

FIG. 2a is a perspective view of the headphone cord sleeve assembled to the headphone cord, with the sleeve in the use position.

FIG. 2b is a perspective view of the headphone cord sleeve assembled to the headphone cord, with the sleeve in the storage position.

FIG. 3 is a top view of the headphone cord sleeve in storage position conforming to the bend of the headphone cord.

FIG. 4 is a perspective view of the headphone cord sleeve in storage position with the jack plug passing through the label putting the headphone cord in a loop that is resilient to tangling.

FIGS. 5a-5c are a series of views showing how a tool included may be used to assemble the headphone cord sleeve onto a headphone cord.

### DETAILED DESCRIPTION OF THE INVENTION

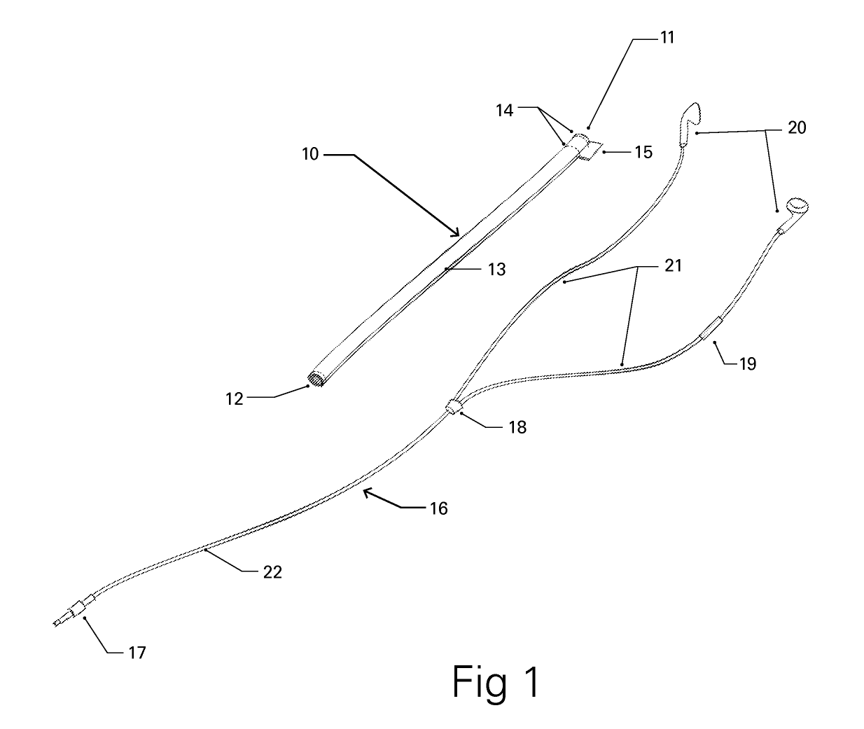

FIG. 1 illustrates an embodiment of a headphone cord sleeve 10. As shown, the headphone cord sleeve 10 is a hollow flexible tube including a front opening 11 and a back opening 12.

As shown in FIG. 1, the example of the headphone cord sleeve 10 shown is made from fabric that is stitched along its length to form a seam 13, stitched at the front end to provide a reinforced section 14 to which a label 15 is also stitched. The headphone cord sleeve 10 is also stitched along the back opening 12. Of course, the embodiment illustrated in FIG. 1 is merely one form in which the headphone cord sleeve 10 may be embodied. The headphone cord sleeve 10 may alternatively be made without stitching along the length to form the seam 13 by using the flat tubular braided construction found commonly in certain athletic shoelaces. Further, the headphone cord sleeve 10 may be made using any method or manufacturing process that may be used to create a flexible tube form out of fabric or non-fabric material.

A generic headphone cord 16 is also shown in FIG. 1. In the example shown, the headphone cord 16 includes a jack plug 17, a cord split 18, a microphone 19, a pair of earbud housings 20, a pair of earbud cords 21 and a jack cord 22. The headphone cord 16 shown in FIG. 1 is believed to be representative of a typical headphone cord 16 for earbud style headphones. However, it is understood that there are variations in earbud style headphones and the headphone cord sleeve 10 may be adapted for use with numerous variations. For example, some headphone cords 16 do not include a microphone 19.

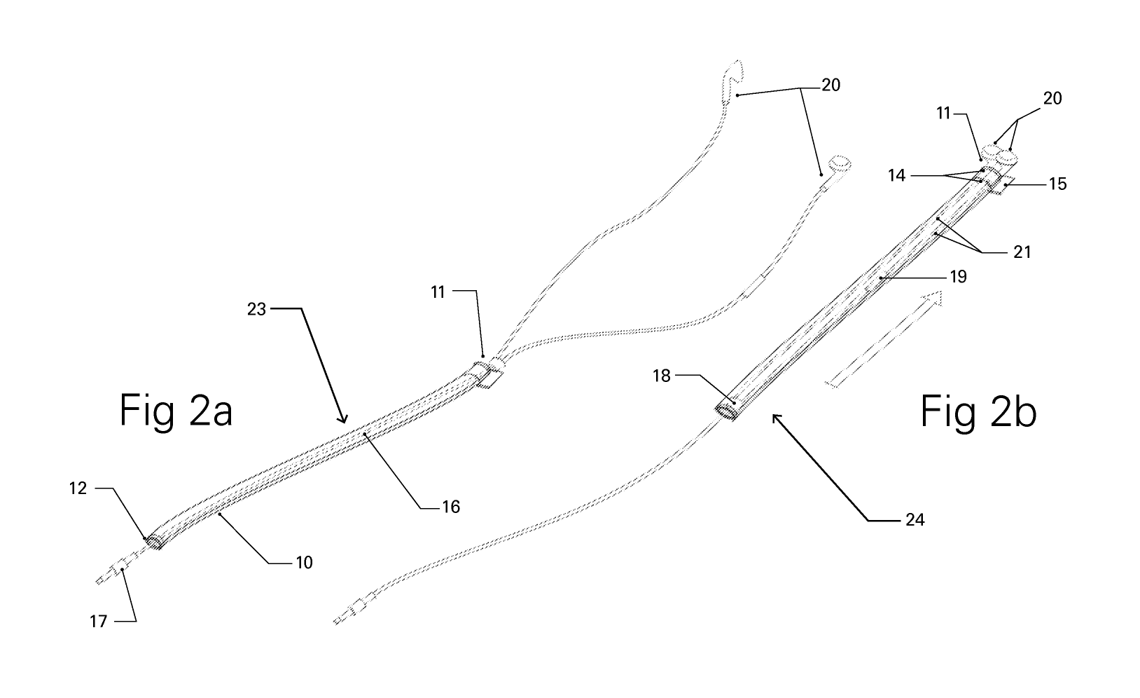

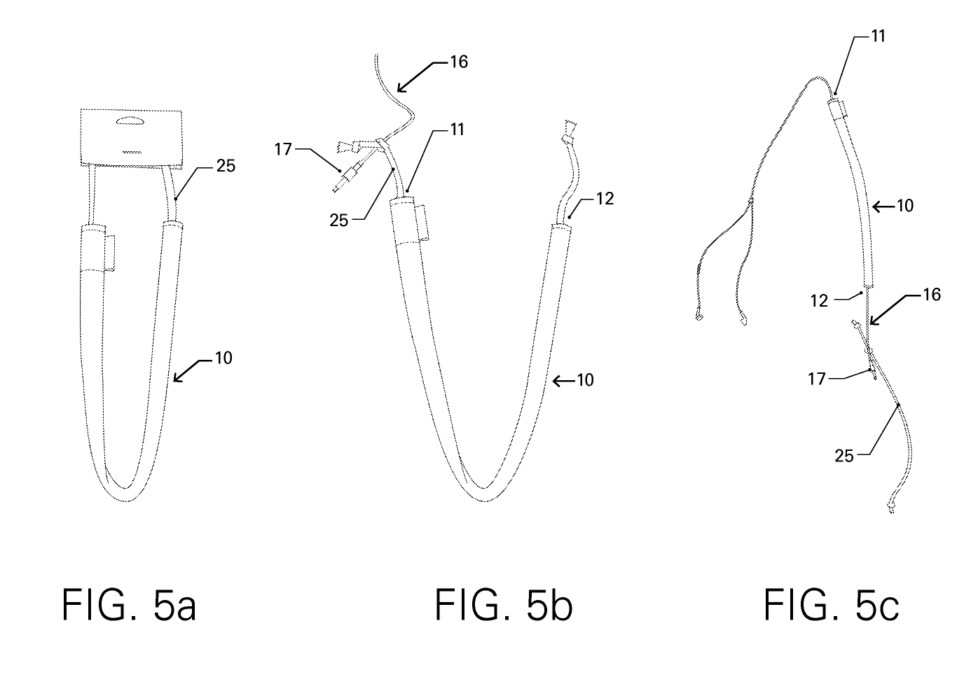

Turning now to FIG. 2a, the headphone cord sleeve 10 is shown located on the headphone cord 16. To assemble the combination of the headphone cord sleeve 10 and the headphone cord 16, the jack plug 17 is fed in through the front opening 11 and out through the back opening 12. A tool 25 may be provided to be used to assist in this one-time assembly step. An example of an appropriate tool 25 is shown in FIG. 5a. In this example, a prepackaged string-tool 25 is threaded through the headphone cord sleeve 10 to enable a user to pull the headphone cord 16 in through the front opening 11 of the headphone cord sleeve 10 (as shown in FIG. 5b) and out through the back opening 12 (as shown in FIG. 5c), to assemble the headphone cord sleeve 10 onto the headphone cord 16. The tool 25 is able to grasp the jack plug 17 using a mating portion, in this example by tying the tool 25 around the end of the headphone cord 16 near the jack plug 17.

Turning back to FIG. 2a, when the jack plug 17 is visible adjacent to the back opening 12 and the cord split 18 is visible adjacent to the front opening 11, the headphone cord sleeve 10 is considered to be in the normal use position 23. In the normal use position 23, the ear bud housings 20 are free to be placed in the user's ears and the jack plug 17 is available to be plugged into the device.

As shown in FIG. 2b, the headphone cord sleeve 10 may alternatively be positioned over the earbud cords 21 in what is referred to herein as the storage position 24. It is believed that it may be easiest to transition the headphone cord sleeve 10 from the use position 23 to the storage position 24 by pulling the headphone cord sleeve 10 by the label 15 or front opening 11. The reinforced section 14 has a stiffening effect that enable the headphone cord sleeve 10 to overcome resistance at the cord split 18, microphone 19 and earbud housings 20. In one example, the reinforced section 14 is created by reinforcing the hollow flexible tube with additional layers of material and stitching; however, it is understood that there may be numerous ways in which the reinforced section 14 may be created. While in the storage position 24, the headphone cord sleeve 10 constrains the earbud cords 21 causing them to behave as a single cord rather than two, creating a continuous cord effect. Also, in the storage position 24, the microphone 19 and cord split 18 are covered by the headphone cord sleeve 10, and thereby are less prone to contributing to tangles in the headphone cord 16. This results in creating an overall benefit of resilience to tangling.

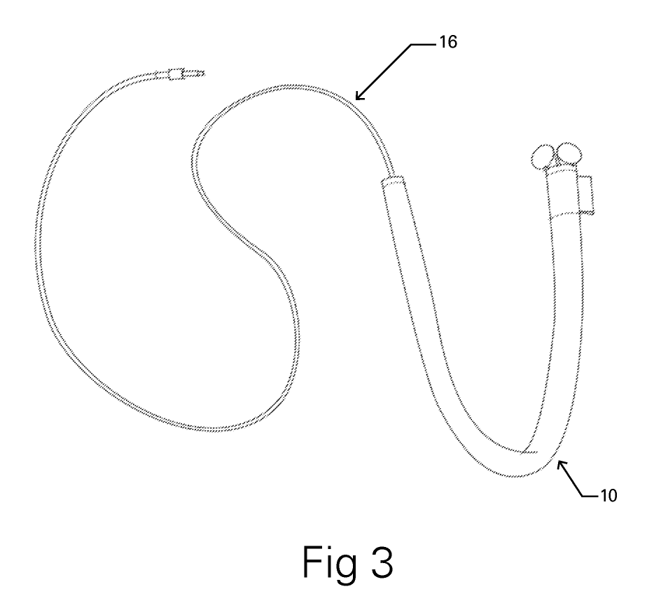

As shown in FIG. 3, due to the flexible material used, the headphone cord sleeve 10 is free to conform to whatever shape the headphone cord 16 requires. This creates a benefit in that it does not constrain the end user with regards to storage shape.

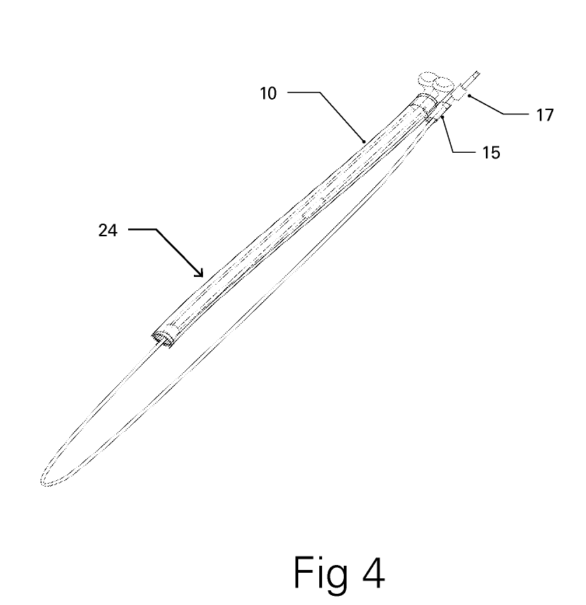

Turning now to FIG. 4, the headphone cord sleeve 10 is shown in the storage position 24. In this example, the label 15 forms a loop adjacent the reinforced section 14. Accordingly, the jack plug 17 may be captured through the label 15 allowing the headphone cord 16 to be more resilient to tangling given there are no loose ends in this configuration.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A headphone cord sleeve comprising:
a flexible tubular sleeve including an opening at each of a first end and a second end;
a reinforced section of the tubular sleeve adjacent the first end reducing the flexibility of the tubular sleeve over the length of the reinforced section; and
a loop extending from the side wall of the flexible tube, adjacent to the reinforced section.

2. The headphone cord sleeve of claim 1 wherein the loop is a product label.

3. The headphone cord sleeve of claim 1 wherein the reinforced section includes stitching and additional layers of material in the flexible tubular sleeve.

4. The headphone cord sleeve of claim 1 further including a tool located through the tubular sleeve wherein the tool includes a mating portion for grasping a headphone cord.

5. A method of managing a headphone cord comprising the steps of:
providing a tubular sleeve including a first opening and a second opening;
positioning the tubular sleeve onto a headphone cord, wherein the headphone cord includes a jack plug, a jack cord, a cord split, a pair of earbud cords and a pair of earbud housings; and
selectively positioning the tubular sleeve between a use position and a storage position, wherein, in the use position, the jack plug is uncovered and adjacent to the first opening of the tubular sleeve and further wherein, in the storage position, the tubular sleeve covers the cord split and the pair of earbud cords creating a continuous cord effect.

6. The method of claim 5 wherein, in the use position, the cord split is uncovered and adjacent to the second opening of the tubular sleeve.

7. The method of claim 5 wherein the step of positioning the tubular sleeve onto a headphone cord includes the step of pulling the headphone cord through the tubular sleeve using a tool provided in the tubular sleeve.

8. The method of claim 5 wherein the tubular sleeve is a flexible tubular sleeve including:
an opening at each of a first end and a second end;
a reinforced section of the tubular sleeve adjacent the first end reducing the flexibility of the tubular sleeve over the length of the reinforced section; and
a loop extending from the side wall of the flexible tube, adjacent to the reinforced section.
